(19) United States
(12) Patent Application Publication
(10) Pub. No.: US 2011/0011657 A1
(43) Pub. Date: Jan. 20, 2011

(54) SOLAR ELECTRIC SCOOTER

(76) Inventors: Michael C. Donnell, Van Nuys, CA (US); Tony VanMeeteren, Woodland Hills, CA (US)

Correspondence Address: Ivan M Posey, 1535 Larktree Way, Hacienda Heights, CA, 91745, US

(21) Appl. No.: 12/835,691

(22) Filed: Jul. 13, 2010

Related U.S. Application Data
(60) Provisional application No. 61/270,914, filed on Jul. 15, 2009.

(51) Int. Cl. B60L 8/00; B23P 17/00

(52) U.S. Cl. 180/65.31; 29/401.1

(57) ABSTRACT

A solar electric scooter with foldable photovoltaic modules is disclosed. According to one preferred embodiment, an apparatus is provided for transportation comprising one or more batteries capable receiving and storing an electric charge. An electric motor may be capable of providing rotational velocity to one or more wheels upon receiving power from the electric batteries. A plurality of foldable photovoltaic modules may comprise solar cells capable of providing electric charge to the one or more batteries.

### RELATED APPLICATION INFORMATION

This Application claims priority from U.S. Provisional Patent Application Ser. No. 61/270,914, entitled SOLAR ELECTRIC TWO WHEEL SCOOTER, filed Jul. 15, 2009.

### FIELD OF THE INVENTION

A solar electric transport apparatus is disclosed. Specifically, a solar electric apparatus has foldable solar modules, allowing for protection of such modules during use of the apparatus, and easy solar charging during non-use of the apparatus.

### BACKGROUND OF THE INVENTION

Presently, many forms of transportation may use pollution-emitting forms of power, including internal combustion engines, and the like. Most vehicles use non-renewable resources, such as gasoline, to power those vehicles.

Many solutions have been tried, but have failed. For example, solar powered vehicles have failed because of the lack of horsepower and the need for sunlight during operation. Further, the panels that hold the solar cells have mostly proven to be too large for aerodynamics, and are cumbersome in terms of vehicle design. Further, these prior art panels have suffered the shortcoming of a lack of sufficient surface area to replenish used up charge in a reasonable amount of time.

None of the above prior devices allow for maximized solar cell area while allowing for aerodynamic storage of such cells during use of the vehicle. Thus a solar electric vehicle solving the aforementioned problems is desired.

### SUMMARY OF THE INVENTION

In order to solve the problems and shortcomings of the prior art, a solar electric transport apparatus with foldable solar cells is disclosed. According to one preferred embodiment, an apparatus is provided for transportation comprising one or more batteries capable of receiving and storing an electric charge. An electric motor may be capable of providing rotational velocity to one or more wheels upon receiving power from the electric batteries. A plurality of foldable photovoltaic modules may comprise solar cells capable of providing electric charge to the one or more batteries.

According to a preferred embodiment, the apparatus may comprise a scooter, having a frame. The foldable modules may form a deck on which an operator of the scooter can place feet when the modules are in a folded configuration. The solar cells may be capable of exposure to light radiation when the foldable modules are in an unfolded configuration.

According to another preferred embodiment, the foldable modules may be located anywhere on the scooter or transportation apparatus. For example, the foldable modules may be located on the bottom a scooter, wherein the user would turn the scooter upside down to unfold and expose the modules to light radiation above.

According to another preferred embodiment, the apparatus may comprise a switch for electrically connecting the foldable modules to the batteries for charging. The switch may be manually operated by the operator. In another preferred embodiment, the switch may be mechanically operated by the unfolding of the solar modules. In yet another preferred embodiment, a soft switch may cause the foldable modules to electrically connect to the batteries upon detection of electrical current from foldable modules. In one preferred embodiment, the switch may prevent operation of the scooter when the foldable modules are electrically connected to the batteries.

According to another preferred embodiment, the photovoltaic modules may comprise thin solar cells that are rolled instead of folded during operation of the transportation apparatus. For example, when a scooter is not in operation, rolled-up modules may be unrolled on the sides of the scooter to lay flat along the ground or over the handlebars to offer maximum light exposure during solar charging.

In another preferred embodiment, a method for retrofitting an existing scooter may comprise providing two or more foldable photovoltaic modules comprising solar cells capable of providing electric charge to one or more batteries; connecting the one or more photovoltaic modules to the one or more batteries; and unfolding the one or more photovoltaic modules to expose the solar cells to light radiation, thereby charging the one or more batteries.

### BRIEF DESCRIPTION OF THE DRAWINGS

FIG. 1 is a left-front perspective view of the a scooter according to one embodiment of the invention with photovoltaic modules having solar cells folded in a position for operation of the scooter;

FIG. 2 is a left-front perspective view the scooter of FIG. 1 with the photovoltaic modules with solar cells partially extended as they are being unfolded to a position for solar charging of the scooter;

FIG. 3 is a left-front perspective view the scooter of FIG. 1 with the photovoltaic modules with solar cells fully extended for charging;

FIG. 4 is an electrical schematic of the charging system for the scooter of FIG. 1;

FIG. 5 is an alternative electrical schematic of the charging system for the scooter of FIG. 1,

FIG. 6 is yet another alternative electrical schematic of the charging system for the scooter of FIG. 1; and

FIG. 7 is a flow diagram illustrating steps for retrofitting an existing scooter according to one embodiment.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

According to one embodiment, a solar-chargeable apparatus, such as a scooter, provides low cost transportation by virtue of the fact that it is receiving electrical power from the sun. The scooter may be of low cost to purchase because it is designed and constructed from readily available, materials. Further, the scooter may be fun to operate, and the fact that the scooter is powered by solar energy gives its owner the opportunity to contribute to the well being of the environment and reduce emissions harmful to humans.

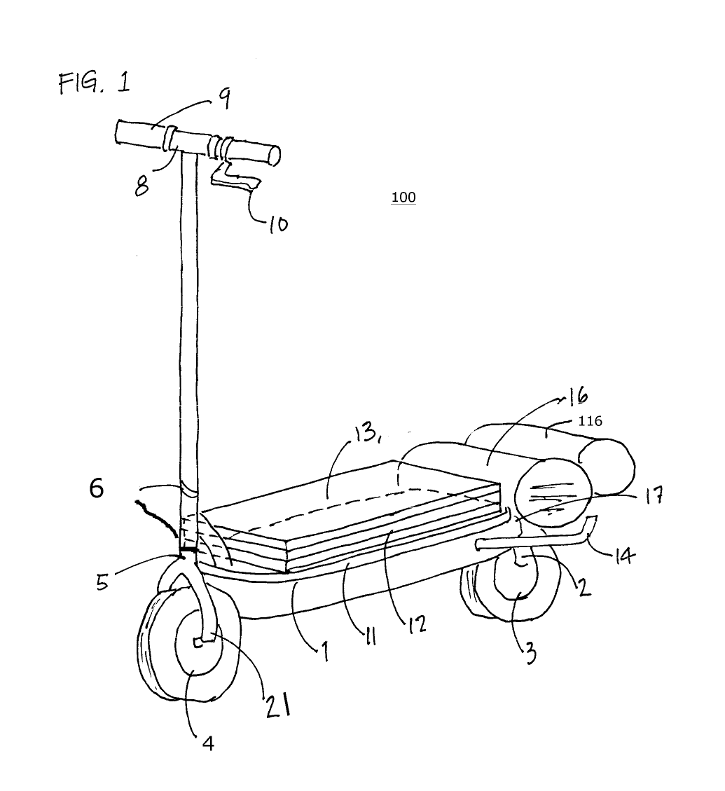

With reference to FIG. 1, a left-front perspective view of a scooter 100 is shown according to one embodiment, with photovoltaic modules 12 folded in a position for operation of the scooter 100. A frame or chassis 1 of the scooter 100 may be comprised of various types of metal or plastic, and horizontally situated. A front fork 21 steerably attaches to the frame 1 and holds a front wheel 4 in place. A rear fork 2 attaches a rear wheel 3 to the frame by horizontal axles mounted between the forks 21 and 2.

At the front of the chassis 1, an elongated metal or plastic steering column 5 may be attached to the front fork 21. In other embodiments, the frame 1, and column 5 may be made of any suitable material such as aluminium or carbon fibre for lightness and strength.

The steering column 5 may rotate with respect to the frame by means of a head tube assembly 6 attached to the chassis 1. In one embodiment the head tube assembly 6 is similar to that on a bicycle as those of skill in the art would recognize. The rider may turn the scooter while operating by rotating the steering column via a handlebar 8. In some embodiments, a telescoping steering column 5 may allow for adjustment of the handlebar 8 to different heights. In one embodiment, the steering column may be hinged with a locking and release device near its lower extremity so that it folds into a horizontal position to facilitate ease of transport.

A throttle 9 may be mounted on the right side of the handle bar 8, and a hand brake lever 10 on the left side. The throttle 9 may be a variable speed twist grip or thumb/finger activated variable speed device.

The hand brake lever 10 may operate a brake attached to the rear wheel. In other embodiments, a front and rear brake is provided, with the rear operated by a foot pedal, and the front operated by the break lever 10.

A deck 11 may sit horizontally astride the middle of the chassis 1. The deck 11 may comprise one or more photovoltaic modules 12 that may be hinged to expand and increase their size to provide a greater exposure of surface to the sun when the scooter 100 is not in use. A photovoltaic module 12, may comprise, for example, and not by way of limitation, a module 12 comprising a cluster of one or more solar cells commonly known to those in the art that convert light radiation into electric current. When the photovoltaic modules 12 are folded into the stowed position (closed as shown in FIG. 1), the operator may stand on the exposed underside of the top photovoltaic module 12. The photovoltaic modules 12 may be connected together by wires and also to a battery 116 for the transmission of electricity from the photovoltaic modules 12 to the battery 116. In some embodiments, one or more batteries 116 may be located in various locations depending on the scooter model; for example, in the front of the frame 1, under the photovoltaic modules 12, or at the rear of the scooter 100 as shown in FIGS. 1-3.

When the photovoltaic modules 12 are in the stowed position, as shown in FIG. 1, the underside 13 of the top stowed photovoltaic module 12, on which the user may stand during operation, may comprise a non-slip material so that the user does not slip. In one embodiment, the photovoltaic module 12 on top of the folded stack may be covered with a clear material with solar cells 42 exposed on the underside, thereby providing charging while the modules 12 are in the folded position.

It should be understood that the photovoltaic modules 12 may be alternative located in one or more of several areas on the transportation apparatus or scooter 100. For example, instead of forming a deck on top of the frame 1 of the scooter 100, the photovoltaic modules 12 may be folded underneath the frame of scooter 100. For example, for charging, the modules 12 may unfold from underneath the scooter 100, or the whole scooter 100 may be turned upside down to unfold and expose the solar cells 42 on the modules to light from above.

In one embodiment, a kickstand 14 is included that may be extended to hold the scooter in an upright position while parked.

In one embodiment, the rear 17 of the chassis 1 houses an electric motor 16 and one or more batteries 116. The drive system for the scooter 100 may include a system known to those skilled in the art that provides a drive mechanism for the rear wheel 3. For example, the rear wheel 3 may be attached to the electric motor 16 by means of a belt, chain or gear that transmits rotational power from the motor 16 to the rear wheel 3. The amount of power delivered to the rear wheel 3 by the motor 16 may be modulated by the user by means of the throttle 10 on the handlebar 8.

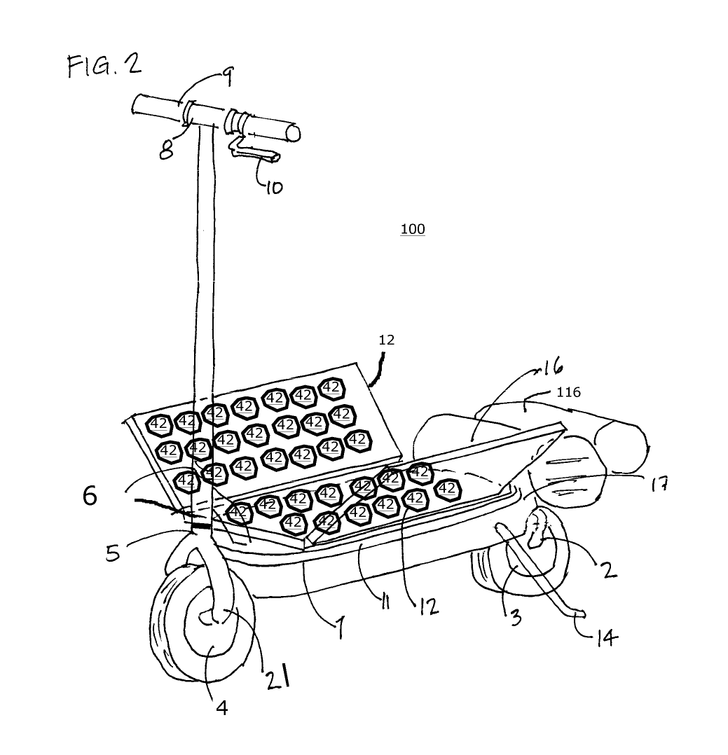

With reference to FIG. 2, a left-front perspective view the scooter 100 of FIG. 1 with the photovoltaic modules 12 partially extended as they are being unfolded to a position for solar charging of the battery(ies) 116 of the scooter 100 is shown. In one embodiment, the batteries 116 may be charged by light radiation (from the sun or otherwise). A photovoltaic electricity generation cells (solar cells) 42 may be located on the inside-top of the photovoltaic modules 12.

In some embodiments, there may be one photovoltaic module 12 or numerous modules 12, with solar cells 42 attached to the inside-top to facilitate the generation of more electricity. If there are numerous modules 12, they may be connected by wires for the continuous transmission of electric charge to the battery 116.

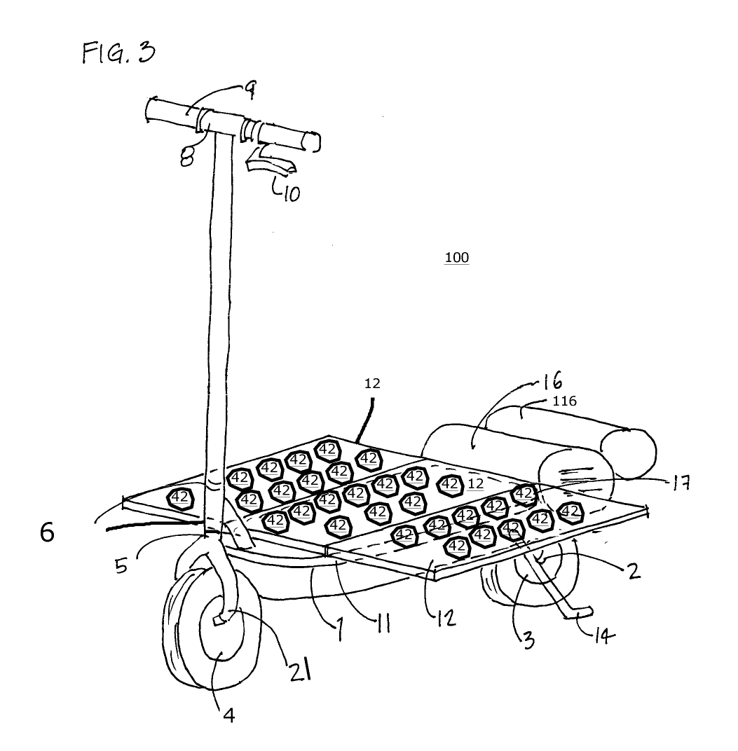

With reference to FIG. 3, a left-front perspective view the scooter 100 of FIG. 1 with the photovoltaic module 12 with solar cells 42 fully extended for charging is shown. In one embodiment, in order for the photovoltaic modules 12 to generate electric charge for the battery 116, the scooter may be placed in the parked position. This is when the photovoltaic modules 12 may be fully extended in their solar charging position as shown in FIG. 3.

In some embodiments, the size and number of the photovoltaic modules 12 may vary, and may be changed from time to time to allow for the generation of additional electrical power to be provided for increased range and time-of use of the scooter 100. The photovoltaic modules 12 may comprise a flat module 12, including a concentrating photovoltaic module 12 on top of the frame 1 or deck, or they may comprise a number of photovoltaic modules 12 that are hinged together and are deployed when the scooter is in the charging position as shown in FIG. 3.

In one embodiment, instead using rigid modules 12, the photovoltaic modules 12 may comprise thin solar cells that may be rolled during storage, and unrolled for solar charging of the scooter 100. For example, rolled-up thin photovoltaic modules 12 may be rolled on or under the deck of the scooter 100, on the side of the scooter 100, on the back, underneath, or even from the handlebar 8 of the scooter 100.

In other embodiments, the scooter 100 may also receive electricity from additional sources. For example, by way of example and not by way of limitation, the scooter 100 may additionally connect to stand alone solar modules not attached to the scooter 100, or a plug in a/c charger may be provided for plug-in charging or charging during night or inclement weather.

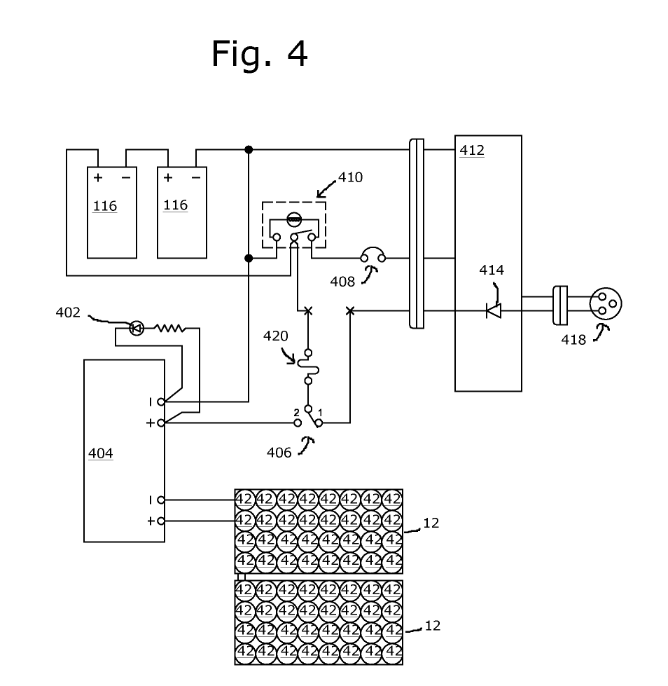

With reference to FIG. 4, an electrical schematic of the charging system for the scooter 100 of FIG. 1 according to one embodiment is shown. As stated above, there may be several methods by which the batteries 116 of the scooter 100 may be charged. The photovoltaic modules 12 with solar cells 42 may be electrically connected to a solar controller 404, that regulates electrical current form the photovoltaic modules 12. When power is being received by the solar controller 404, a light emitting diode (LED), which is electrically connected to the solar controller 404, is lit. A negative, or ground, lead may be connected to the ground, or negative lead side of the batteries 116. However, the positive lead from the solar controller 404 may be routed to a switch 406 mounted on the steering column 5 or handlebar 8. In one embodiment, this switch 406 may be activated manually by the user when the photovoltaic modules 12 are unfolded for solar charging of the batteries 116.

After the switch 406, the positive lead is routed through a fuse 420 to an on/off switch 410 for operation of the scooter 100. In this respect, when the switch 410 is in the on position for operation of the scooter 100 by the user, then the solar modules 12 may not be used to charge the batteries 116. Thus, the positive lead is cut off by the switch 410 when the on/off switch 410 is in the operating position for the scooter 100.

In the embodiment of FIG. 4, a charging port 418 for a/c plug-in charging is further provided. The switch 406 mounted on the steering column 5 may be put into a plug-in charge position to charge via the plug-in a/c charging port 418 instead of the modules 12. On a scooter control circuit board 412, a reverse polarity protection diode 414 provides for single direction current through the positive lead. The negative lead from the plug-in a/c charging port 418 is routed through the scooter's circuit breaker 408 to prevent overloading damage to the scooter's electronics during plug-in charging.

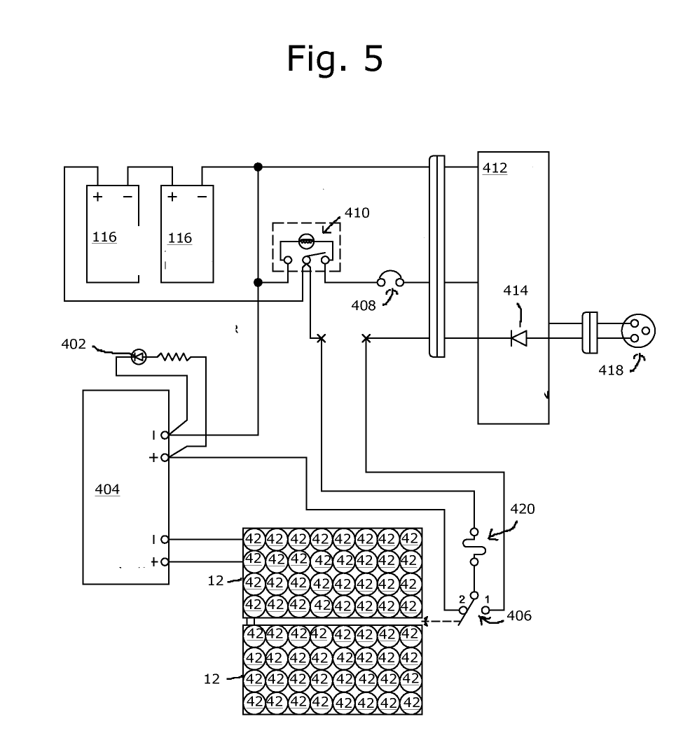

With reference to FIG. 5, an alternative electrical schematic of the charging system for the scooter of FIG. 1 is shown. The switch 406 may be activated by opening of the photovoltaic modules 12, and deactivated by closing of the modules 12.

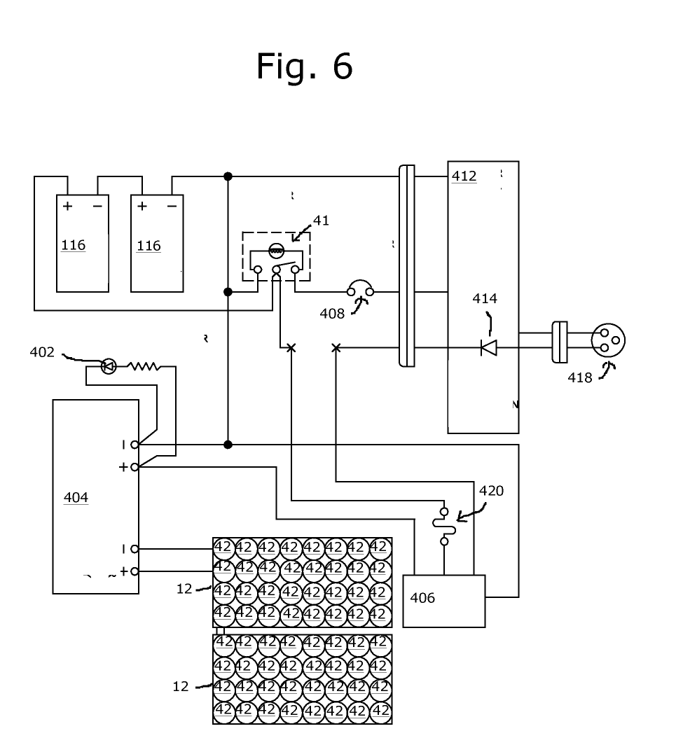

With reference to FIG. 6, yet another alternative electrical schematic of the charging system for the scooter of FIG. 1 is shown. In the Embodiment of FIG. 6, the switch 406 comprises an electronic soft switch that is activated upon detection of current from the photovoltaic modules 12 or by the solar controller 404 to direct charging of the batteries from the photovoltaic modules 12 instead of the a/c charging port 418.

In one embodiment, existing scooters may be modified using a retrofit kit to convert it into a solar charging scooter. The bottom photovoltaic module 12 in the stack may have integrated brackets that facilitate the attachment of the stack of photovoltaic modules 12 to the deck of an electric scooter 100. In some embodiments, the brackets may be pre-measured and mounted on the bottom module 12 so that they are situated to fit existing screw holes in existing models of scooters 100.

The bottom photovoltaic module 12 may have a frame around its perimeter that, when attached to the scooter 100, holds the module 12 above the scooter frame 1, forming a cavity between the bottom of the photovoltaic module 12 and the top of the scooter frame 1. This cavity may contain following sub-parts: the solar controller 404; the switch 406 that is integrated into the frames of the modules 12, and that activates the solar controller 404 when the modules 12 are unfolded to accept sun light; the fuse 420; and the LED 402, which may be installed in the outer frame of the bottom module 12. Wires may be extended from under the bottom photovoltaic module 12 that are used to connect to the electrical circuitry inside the scooter battery compartment.

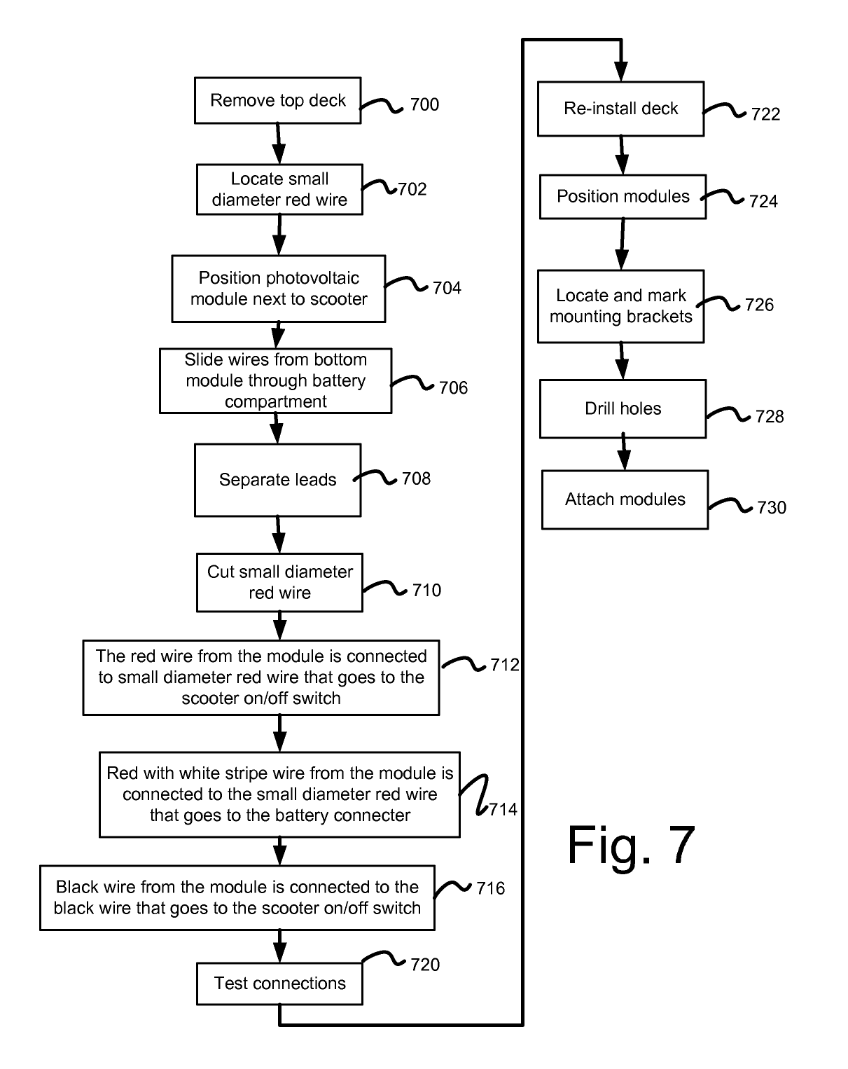

With reference to FIG. 7, a flow diagram illustrates a method of connecting the retrofit kit to an existing or prior-art scooter 100. A retrofit kit can be installed using the following minimum tools: phillips screwdriver, blade screwdriver, pliers, wire cutters, and an ohmmeter.

In step 700, the top deck of the scooter 100 being retrofitted is removed, exposing or opening the battery compartment. In step 702 the user may locate the small diameter red wire connected at one end to the scooter on/off switch. In step 704, the photovoltaic modules 12 are positioned next to the scooter 100. In step 706, the wires that extend from under the bottom photovoltaic module 12 are pulled out and slid through a hole in the side of the battery compartment. In step 708, the wire leads are separated. In step 710, in the scooter battery compartment, the small diameter red wire is cut. In step 712, the red wire from the module is connected to the small diameter red wire that goes to the scooter on/off switch. In step, 714, the red with white stripe wire from the module is connected to the small diameter red wire that goes to the battery connecter. In step 716, the black wire from the module is connected to the black wire that goes to the scooter on/off switch. Quick connection wire connectors may be supplied so that the wires do not need to be stripped to be connected. In step 720, the connections are tested using the ohmmeter. In step 722, the deck of the scooter is re-installed and screwed into place. In step 724, the modules are positioned on top of the scooter deck. In step 726, the mounting brackets are located and marked in the scooter deck where the holes in the brackets contact the scooter deck. In step 728, ⅛ inch holes are drilled in the scooter deck. In step 730, using the screws that are inserted into the holes made in the deck to attach the photovoltaic modules 12.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. An apparatus for transportation, comprising:
one or more batteries capable receiving and storing an electric charge;
an electric motor capable of providing rotational velocity to one or more wheels upon receiving power from the batteries; and
a plurality of foldable photovoltaic modules comprising solar cells capable of providing electric charge to the one or more batteries.

2. The apparatus of claim 1, comprising a scooter, having a frame.

3. The apparatus of claim 2, wherein the foldable photovoltaic modules form a deck on which an operator of the scooter can place feet when the photovoltaic modules are in a folded configuration.

4. The apparatus of claim 3, wherein the solar cells are capable of exposure to light radiation when the foldable photovoltaic modules are in an unfolded configuration.

5. The apparatus of claim 4, further comprising a switch for electrically connecting the photovoltaic modules to the batteries for charging.

6. The apparatus of claim 5, wherein the switch is manually operated by the operator.

7. The apparatus of claim 5, wherein the switch is mechanically operated by the unfolding of the photovoltaic modules.

8. The apparatus of claim 5, wherein the switch comprises a soft switch that causes the photovoltaic modules to electrically connect to the batteries upon detection of electrical current from foldable modules.

9. The apparatus of claim 5, wherein the switch prevents operation of the scooter when the photovoltaic modules are electrically connected to the batteries.

10. A method for retrofitting an existing scooter, comprising:
providing two or more foldable photovoltaic modules comprising solar cells capable of providing electric charge to one or more batteries;
connecting the one or more photovoltaic modules to the one or more batteries; and
unfolding the one or more photovoltaic modules to expose the solar cells to light radiation, thereby charging the one or more batteries;

11. The method of claim 10, wherein the scooter has a frame.

12. The method of claim 11, comprising installing the two or more photovoltaic modules to form a deck on the scooter, and on which an operator of the scooter places feet when the two or more photovoltaic modules are in a folded configuration.

13. The method of claim 10, further comprising installing a switch for electrically connecting the photovoltaic modules to the batteries for charging.

14. The method of claim 13, wherein the switch is manually operated by the operator.

15. The method of claim 13, wherein the switch is mechanically operated by the unfolding of the photovoltaic modules.

16. The method of claim 13, wherein the switch comprises a soft switch that causes the photovoltaic modules to electrically connect to the batteries upon detection of electrical current from photovoltaic modules.

17. The method of claim 13, wherein the switch prevents operation of the scooter when the photovoltaic modules are electrically connected to the batteries.

18. An apparatus for transportation, comprising:
one or more batteries capable receiving and storing an electric charge;
an electric motor capable of providing rotational velocity to one or more wheels upon receiving power from the batteries; and
one or more rollable photovoltaic modules comprising solar cells capable of providing electric charge to the one or more batteries.

19. The apparatus of claim 18, wherein the rollable photovoltaic module is attached to the a side of the apparatus for transportation.

20. The apparatus of claim 18, wherein the rollable photovoltaic module is attached to the a bottom of the apparatus for transportation.
